(19) United States
(12) Patent Application Publication
(10) Pub. No.: US 2012/0167460 A1
(43) Pub. Date: Jul. 5, 2012

(54) CULTIVATION SYSTEM FOR MEDICINAL VEGETATION

(76) Inventor: Julian Omidi, Las Vegas, NV (US)

(21) Appl. No.: 13/341,909

(22) Filed: Dec. 31, 2011

Related U.S. Application Data
(60) Provisional application No. 61/428,974, filed on Dec. 31, 2010.

(51) Int. Cl. A01G 9/02; F21V 9/00; F21V 29/02; F21V 7/00

(52) U.S. Cl. 47/65.7; 47/82; 47/66.6; 362/235; 362/231

(57) ABSTRACT

The present invention is comprised of a stackable cultivation tower system for creating a facility and process that is used to cultivate vegetation in a reduced indoor physical area, conserve resources and promote faster plant. The present invention is further comprised of vertically stacked components for planting vegetation to be cultivated to reduce the space, an irrigation system that is regulated to optimally control application of water and a light source to provide various types of lighting to promote faster growth. The components are commercially readily available and at costs that allow the stackable cultivation tower system to produce faster growth, higher yields economically.

### BACKGROUND

The cultivation of plants and vegetables started early in the history of mankind. It has been characterized by large tracts and small plots of land that were tilled, planted and harvested. The crops planted were completely at the mercy of the weather and availability of water. The hard work of the farmer often went unrewarded with crop failure due to drought, errant temperatures too hot or too cold and the condition of the soil which may have been depleted of nutrients from over cultivation. Improved farming methods such as crop rotation and irrigation methods developed over the centuries have helped. But at the same time land development and urbanization on top of arable land has pushed agriculture farther away from the urban centers where the largest populations need food.

### BRIEF DESCRIPTION OF THE DRAWINGS

FIG. 1 shows a block diagram of an overview of a stackable cultivation tower system of one embodiment of the present invention.

FIG. 2 shows a block diagram of an overview flow chart of a stackable cultivation tower system of one embodiment of the present invention.

FIG. 3A shows for illustrative purposes only shows an example of an all hub single wye stackable plant holder in prospective view of one embodiment of the present invention.

FIG. 3B shows for illustrative purposes only shows an example of a slip-hub single wye stackable plant holder in prospective view of one embodiment of the present invention.

FIG. 3C shows for illustrative purposes only shows an example of a mesh pot in prospective view of one embodiment of the present invention.

FIG. 3D shows for illustrative purposes only an example of an all hub double wye stackable plant holder in prospective view of one embodiment of the present invention.

FIG. 4 shows for illustrative purposes only shows examples of a stackable cultivation tower component assembly in a prospective view of one embodiment of the present invention.

FIG. 5A shows for illustrative purposes only an example of a stackable cultivation tower with all hub single wyes in a side view of one embodiment of the present invention.

FIG. 5B shows for illustrative purposes only shows an example of a stackable cultivation tower with slip-hub wyes in a side view of one embodiment of the present invention.

FIG. 5C shows for illustrative purposes only shows an example of a stackable cultivation tower with all hub double wyes in a side view of one embodiment of the present invention.

FIG. 5D shows for illustrative purposes only shows an example of a stackable cultivation tower with all hub single wyes in staggered positions in a front view of one embodiment of the present invention.

FIG. 6 shows for illustrative purposes only an example of a stackable cultivation tower system with multiple towers in a plan view of one embodiment of the present invention.

FIG. 7 shows a block diagram of a flow chart of a stackable cultivation tower system cool vertical light tube system of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of a stackable cultivation tower system is described for illustrative purposes and the underlying system can apply to any number and multiple types of stackable plant modules. In one embodiment of the present invention, the stackable plant module is configured as a single plant container. In another embodiment the stackable plant module can be configured as a multiple plant container and can be configured using white PVC plastic or other forms, colors, shapes, sizes and depictions using the present invention.

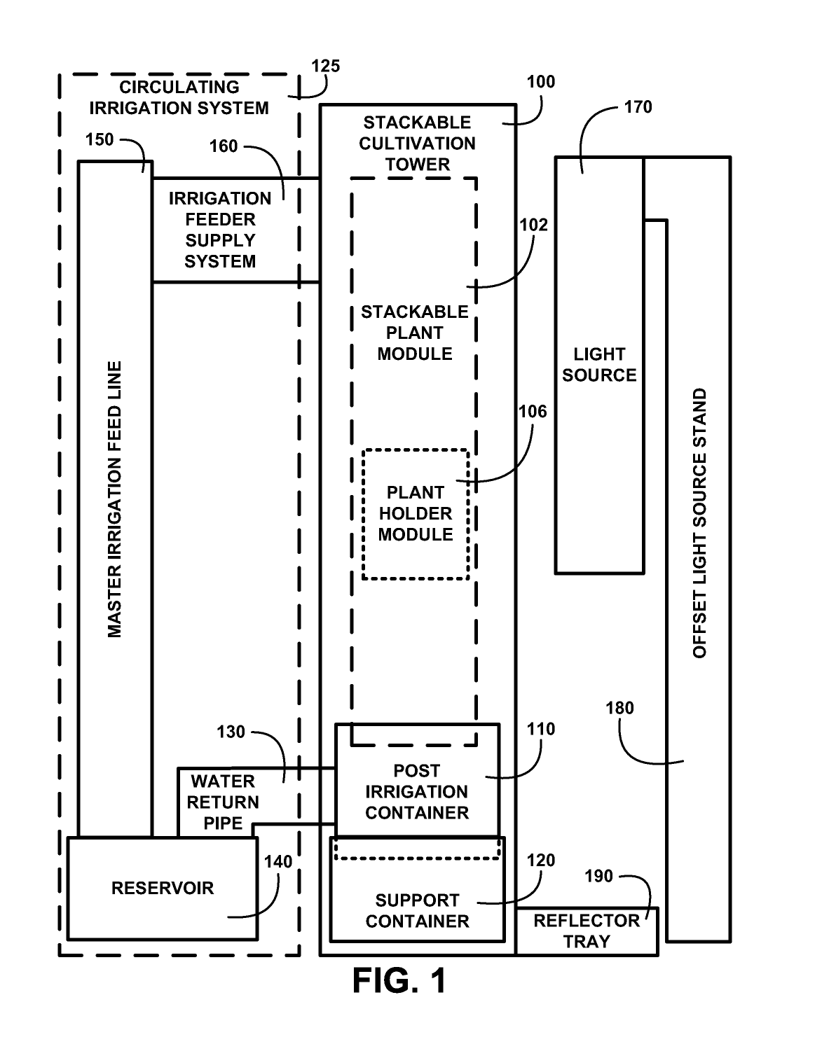

FIG. 1 shows a block diagram of an overview of a stackable cultivation tower system of one embodiment of the present invention. FIG. 1 shows a stackable cultivation tower 100 assembled from various components such as one or more stackable plant module 102 at varying heights above the floor level. Each stackable plant module 102 contains one or more plant holder module 106 in which vegetation can be planted for cultivation. The bottom stackable plant module 102 is connected to a post irrigation container 110. The post irrigation container 110 is inserted into a larger support container 120 to add physical stability to the tower. The vertical configuration of the stackable cultivation tower 100 allows more plants to be cultivated per square foot of floor or ground area than field or soil garden cultivation of one embodiment of the present invention.

The stackable cultivation tower system includes one or more light source 170 components installed on an offset light source stand 180. The light source 170 is positioned to cast light onto the vegetation being cultivated in each plant holder module 106 to promote growth. A reflector tray 190 can be positioned on the floor surface below the light source 170 to reflect the illumination on the underside of the vegetation to allow full illumination to all portions of the vegetation.

The offset distance of the offset light source stand 180 can be adjusted to allow additional space for multiple stackable cultivation tower 100 assemblies to be arranged around the light source 170 illumination of one embodiment of the present invention. The stackable cultivation tower system includes a circulating irrigation system 125 that conserves water and reduces evaporation. A reservoir 140 is the supply source of water and for example nutrients mixed in the water to irrigate and feed the vegetation. The reservoir 140 can be configured to include a pump. The pump forces water from the reservoir 140 up a master irrigation feed line 150. The pump can be configured for example as a submersible pump to pump. The pump can be configured for example with a timer to regulate the irrigation cycle. The timer can be configured to control the operation of the pump to draw water from the reservoir 140 at preset or variable time intervals. The regulated irrigation cycle can pump water through the master irrigation feed line 150 and apply irrigation to the plants at optimal intervals for different vegetation types. The regulated irrigation cycle can prevent over watering which could for example damage roots and allows optimal irrigation to promote faster higher yielding growth. The master irrigation feed line 150 includes piping to convey the water to one or more irrigation feeder supply system 160 assemblies of one embodiment of the present invention.

The irrigation feeder supply system 160 can be configured to include branched piping configured to deliver water to the individual plants in each plant holder module 106. Water draining from each plant holder module 106 down the inside of the stackable cultivation tower 100 is collected in the post irrigation container 110. The higher position of the post irrigation container 110 allows the collected water to gravity flow through a water return pipe 130 to the reservoir 140 for reuse. The transport of the water through the circulating irrigation systems reduce the time in which the water is exposed to conditions that create evaporative losses and eliminates the seepage into soil that normally occurs in field or garden soil cultivation of one embodiment of the present invention.

The stackable cultivation tower system can be assembled from components which are commercially readily available and economically priced. The stackable cultivation tower system can be configured with multiple stackable cultivation tower 100 assemblies, multiple irrigation feeder supply system 160 assemblies and one or more light source 170 allowing many plants to be cultivated economically under optimum conditions in a very small space. The stackable cultivation tower system provides a facility and process that can be used to cultivate vegetation in a reduced indoor physical area, conserves resources and promotes faster plant growth of one embodiment of the present invention.

### Detailed Operation:

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

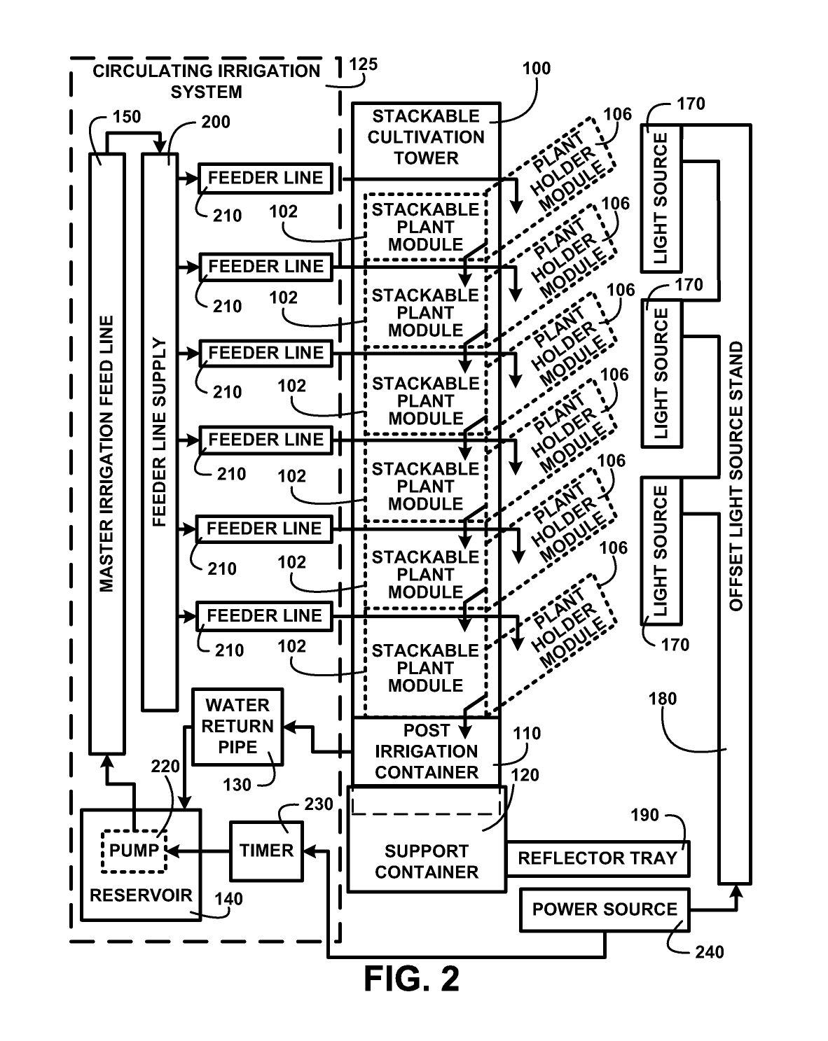

FIG. 2 shows a block diagram of an overview flow chart of a stackable cultivation tower system of one embodiment of the present invention. FIG. 2 shows the stackable cultivation tower 100 configured with multiple stackable plant modules 102 components. Each stackable plant module 102 has one or more plant holder module 106 integrated into the component. Inserted into the plant holder module 106 components is one or more mesh pot containing plants for cultivation of one embodiment of the present invention.

The master irrigation feed line 150 supplies water and nutrients to the plants to promote growth. The reservoir 140 is filled with water and for example liquid nutrients can be added into the water. A pump 220 for example a submersible pump is operated from a power source 240. The power source 240 can be any source of electricity such as utility supplied current, solar panels or wind power. The current to operate the pump 220 passes through a timer 230 to regulate the length of time and frequency of the irrigation supply. The timer 230 allows irrigation adjustments for example for different plant requirements and can provide non-irrigated periods of time for cultivation purposes such as the absorption of oxygen by the root systems. The pump 220 during an irrigation cycle provides the head pressure to pump the water up the master irrigation feed line 150 to the irrigation feeder supply system 160 piping which delivers water to each of the plants in the plant holder module 106 modules of one embodiment of the present invention.

The water nourishes the plants and roots then drains out of the mesh pot into the interior of the stackable cultivation tower 100 column created by the stackable plant module 102 components. The water drains through the bottom stackable plant module 102 which is attached through the lid or cover of the post irrigation container 110. The post irrigation container 110 can be for example a 3 gallon plastic bucket which is installed into the support container 120 which can be a larger container such as a 5 gallon plastic bucket. The support container 120 can be weighed with for example water or gravel to create a stable support for the stackable cultivation tower 100. The irrigation water draining from the mesh pots collects in the post irrigation container 110.

The irrigation water then drains from the elevated position of the post irrigation container 110 by gravity through the water return pipe 130 into the reservoir 140. The recycling of the irrigation water reduces the overall consumption of water used for cultivation by eliminating seepage into the soil and outdoor evaporation of one embodiment of the present invention.

The stackable cultivation tower system provides one or more light source 170 to supply light for processes such as photosynthesis in the plants to stimulate growth. The light source 170 can be configured with various types of light bulbs capable of providing different wavelengths of light levels to simulate light indoors that would be available in sunlight. The light source 170 can be configured to include one or more types of lights for example High Pressure Sodium and Metal Halide lighting. High Pressure Sodium and Metal Halide lights produce stronger, healthier seed starts, faster maturing plants, higher yields and increased flowering. High Pressure Sodium lamps provide more yellow/orange/red spectrum, which is ideal for most plants that are actively fruiting and flowering. Metal Halide lamps provide more of the blue/green spectrum, which is ideal for leafy crops, and/or plants that are in a vegetative (actively growing) stage. The light source 170 components are installed in mogul sockets connected in parallel which are attached to the end of the offset extensions of the offset light source stand 180. The sockets are supplied with electricity through circuits attached to the offset light source stand 180 structure and connected to the power source 240. A reflector tray 190 for example configured using the reflective characteristics of Mylar plastic sheets can be positioned on the floor surface below the light source 170 to reflect the illumination to the underside of the vegetation to allow full illumination to all portions of the vegetation of one embodiment of the present invention.

The stackable cultivation tower system installed indoors eliminates tilling, soil preparation, extensive irrigation canals or piping, exposure to insect damage and use of insecticides, crop damage due to unpredictable drought, floods and variant temperatures. The stackable cultivation tower system requires only a small area within which many plants can cultivated. It reduces water use with recycling while supplying dependable consistent irrigation. The stackable cultivation tower system allows cultivation of any variety of plants in a controlled environment that promotes rapid growth and high yields of harvested quality plant products in a fraction of the space required by conventional agricultural methods of one embodiment of the present invention.

### Stackable Cultivation Tower Components:

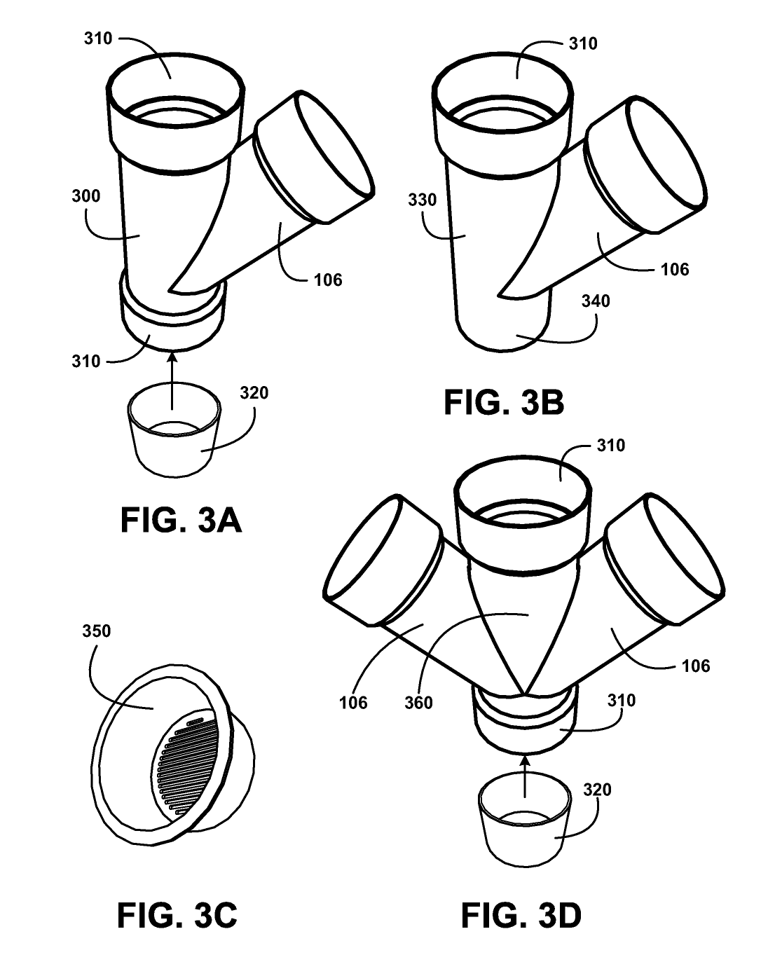

FIGS. 3A, 3B, 3C and 3D shows for illustrative purposes only examples of stackable cultivation tower components of one embodiment of the present invention. The use of various components allows the stackable cultivation tower to adapt to space availability, vegetation type variations and cultivation productivity goals of one embodiment of the present invention.

FIG. 3A shows for illustrative purposes only shows an example of an all hub single wye stackable plant holder in prospective view of one embodiment of the present invention. 3A shows an all hub single wye 300 stackable plant module 102 of FIG. 1 component which can be configured to construct the stackable cultivation tower 100 of FIG. 1. The all hub single wye 300 has a hub end 310 at the top and bottom. The 45 degree angled wye is the plant holder module 106. The all hub single wye 300 can be for example pre-formed PVC fitting of one embodiment of the present invention.

An interior coupling 320 can be for example a section of pipe of an outside dimension matching the interior dimension of the hub end 310 cut to twice the length for insertion into the hub end 310. The interior coupling 320 is inserted into either the top or bottom hub end 310 of the all hub single wye 300. The balance of the length of the interior coupling 320 is inserted into the hub end 310 of the corresponding all hub single wye 300 hub end 310 positioned above or below thereby joining the two all hub single wye 300 sections. An adhesive such as PVC cement is can be used to secure the inserted interior coupling 320 to both of the all hub single wye 300 components forming a section of the stackable cultivation tower 100 of FIG. 1. The number of all hub single wye 300 stackable plant module 102 sections configured to form the stackable cultivation tower 100 of FIG. 1 can be adapted to the space available. The number of all hub single wye 300 sections can be for example in a room with an 8 foot ceiling height be a total of 6 sections allowing 6 individual plants or plant groups to be cultivated per stackable cultivation tower 100 of FIG. 1 of one embodiment of the present invention.

FIG. 3B shows for illustrative purposes only shows an example of a slip-hub single wye stackable plant holder in prospective view of one embodiment of the present invention. 3B shows a slip-hub single wye 330 stackable plant module 102 of FIG. 1 component which can be configured to construct the stackable cultivation tower 100 of FIG. 1. The slip-hub single wye 330 has a hub end 310 at the top and a slip end 340 bottom. The 45 degree angled wye is the plant holder module 106. The slip-hub single wye 330 can be for example a pre-formed PVC fitting. The slip end 340 at the bottom of the slip-hub single wye 330 inserts into the hub end 310 at the top of the corresponding slip-hub single wye 330 below. An adhesive such as PVC cement is can be used to secure the stacked joint insertion. The overall length of the stacked slip-hub single wye 330 sections is reduced due to the insertion of the slip end 340 portion. The number of slip-hub single wye 330 stackable plant module 102 sections configured to form the stackable cultivation tower 100 of FIG. 1 can be adapted to the space available. The number of slip-hub single wye 330 sections can be for example in a room with an 8 foot ceiling height, are a total of 7 sections allowing 7 individual plants or plant groups to be cultivated per stackable cultivation tower 100 of FIG. 1 of one embodiment of the present invention.

FIG. 3C shows for illustrative purposes only shows an example of a mesh pot in prospective view of one embodiment of the present invention. FIG. 3C shows a mesh pot 350 which can be used to plant vegetation for cultivation. The mesh pot 350 is filled with a well draining planting medium which can be for example consist of clay, lava rock and/or perlite. The mesh pot 350 is inserted into the plant holder module 106 of FIG. 1. Irrigation of the vegetation planted in the mesh pot 350 can be configured in various modes. One irrigation mode can be configured with an exterior feed line terminating with a sprayer tip can be positioned above the plant holder module 106 of FIG. 1. The exterior feed line can be tied to stake inserted into the planting medium within the mesh pot 350 thereby feeding the plant stems and foliage. Another irrigation mode can be configured by drilling a hole through the plant holder module 106 of FIG. 1 and mesh pot 350 and inserting the irrigation feeder line 210 of FIG. 2 through the hole thereby feeding the planting mix and the roots of a clone or seedling. The variation of the irrigation modes allows different irrigation methods that best promote growth for differing types of vegetation of one embodiment of the present invention.

FIG. 3D shows for illustrative purposes only an example of an all hub double wye stackable plant holder in prospective view of one embodiment of the present invention. 3D shows an all hub double wye 360 stackable plant module 102 of FIG. 1 component which can be configured to construct the stackable cultivation tower 100 of FIG. 1. The all hub double wye 360 has a hub end 310 at the top and bottom. The 45 degree angled wye is the plant holder module 106. The all hub double wye 360 can be for example pre-formed PVC fitting of one embodiment of the present invention. The interior coupling 320 and an adhesive can be to join two corresponding all hub double wye 360 sections to form a section of the stackable cultivation tower 100 of FIG. 1. The number of all hub double wye 360 stackable plant module 102 sections configured to form the stackable cultivation tower 100 of FIG. 1 can be adapted to the space available. The number of all hub double wye 360 sections can be for example in a room with an 8 foot ceiling height be a total of 6 sections allowing 12 individual plants or plant groups to be cultivated per stackable cultivation tower 100 of FIG. 1 of one embodiment of the present invention.

### Tower Component Assembly:

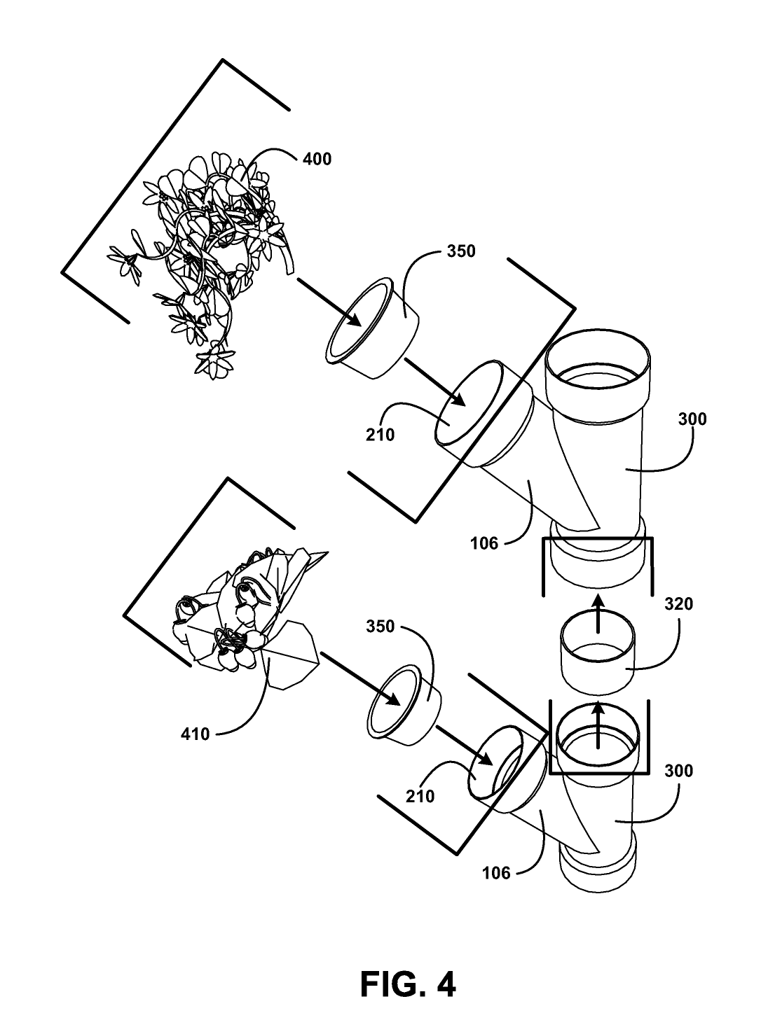

FIG. 4 shows for illustrative purposes only shows examples of a stackable cultivation tower component assembly in a prospective view of one embodiment of the present invention. FIG. 4 shows the assembly of two stackable plant module 102 components configured as all hub single wye 300 sections. Vegetation to be cultivated for example a flowering plant 400 is planted into the well draining planting medium which has been prepared in the mesh pot 350. The planted mesh pot 350 is inserted into the hub end 310 of the plant holder module 106 of the upper all hub single wye 300 of one embodiment of the present invention.

A different type of vegetation to be cultivated for example a fruit plant 410 is planted into the well draining planting medium which has been prepared in the mesh pot 350. The planted mesh pot 350 is inserted into the hub end 310 of the plant holder module 106 of the lower all hub single wye 300 of one embodiment of the present invention.

An interior coupling 320 is coated with an adhesive and inserted into the upper all hub single wye 300. The remaining exposed portion of the interior coupling 320 is coated with an adhesive and inserted into the lower all hub single wye 300. The assembled components complete a section of the stackable cultivation tower 100 of FIG. 1 of one embodiment of the present invention.

### Stackable Cultivation Tower Configurations:

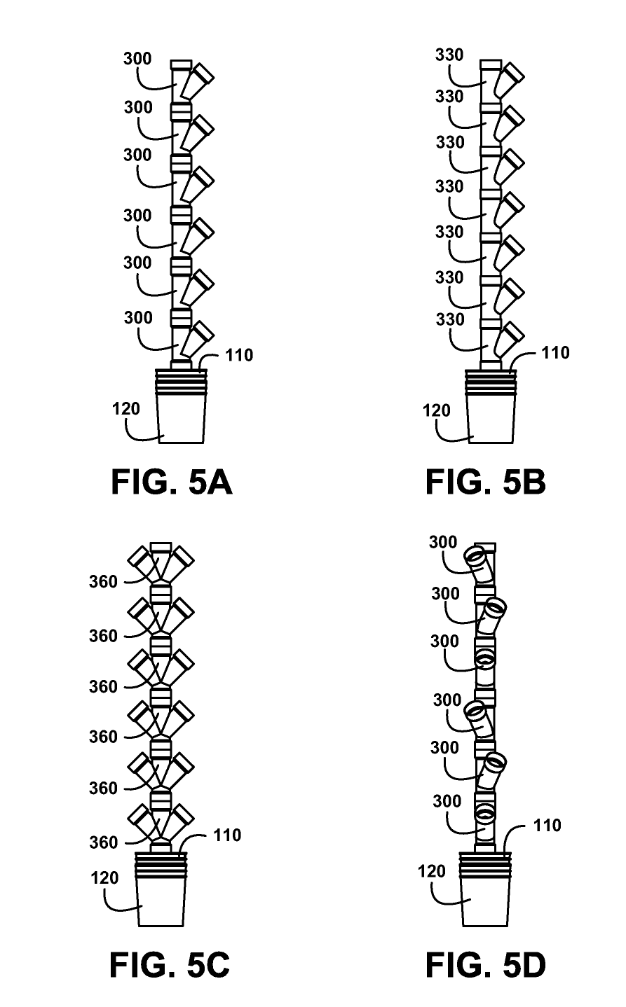

The stackable cultivation tower can be assembled in various configurations using different components and oriented in differing positions. FIG. 5A, FIG. 5B, FIG. 5C and FIG. 5D shows for illustrative purposes only examples of some of the stackable cultivation tower configurations. FIG. 5A shows for illustrative purposes only an example of a stackable cultivation tower with all hub single wyes in a side view of one embodiment of the present invention. In FIG. 5A the post irrigation container 110 is inserted into the support container 120 as the stable base of the tower. Connected to the post irrigation container 110 are six of the stackable plant module 102 components of FIG. 1 configured as all hub single wye 300 sections allowing 6 plants to be cultivated per stackable cultivation tower.

FIG. 5B shows for illustrative purposes only shows an example of a stackable cultivation tower with slip-hub wyes in a side view of one embodiment of the present invention. In FIG. 5B the post irrigation container 110 is inserted into the support container 120 as the stable base of the tower. Connected to the post irrigation container 110 are seven of the stackable plant module 102 components of FIG. 1 configured as slip-hub single wye 330 sections allowing 7 plants to be cultivated per stackable cultivation tower.

FIG. 5C shows for illustrative purposes only shows an example of a stackable cultivation tower with all hub double wyes in a side view of one embodiment of the present invention. In FIG. 5C the post irrigation container 110 is inserted into the support container 120 as the stable base of the tower. Connected to the post irrigation container 110 are six of the stackable plant module 102 components of FIG. 1 configured as all hub double wye 360 sections allowing 12 plants to be cultivated per stackable cultivation tower.

FIG. 5D shows for illustrative purposes only shows an example of a stackable cultivation tower with all hub single wyes in staggered positions in a front view of one embodiment of the present invention. FIG. 5D the post irrigation container 110 is inserted into the support container 120 as the stable base of the tower. Connected to the post irrigation container 110 are six of the stackable plant module 102 components of FIG. 1 configured as all hub single wye 300 sections allowing 6 plants to be cultivated per stackable cultivation tower. The all hub single wye 300 sections are oriented at different angles to the concentric center axis of the stackable plant module 102 components of FIG. 1. The orientation at different angles form staggered positions which for example reduces level of shading on the plant below and better access to the light source 170 illumination. The staggered positions additionally for example provide additional growing room for vegetation types which may hang or drape from the of the plant holder module 106 of FIG. 1 of one embodiment of the present invention.

### Multiple Towers Configuration:

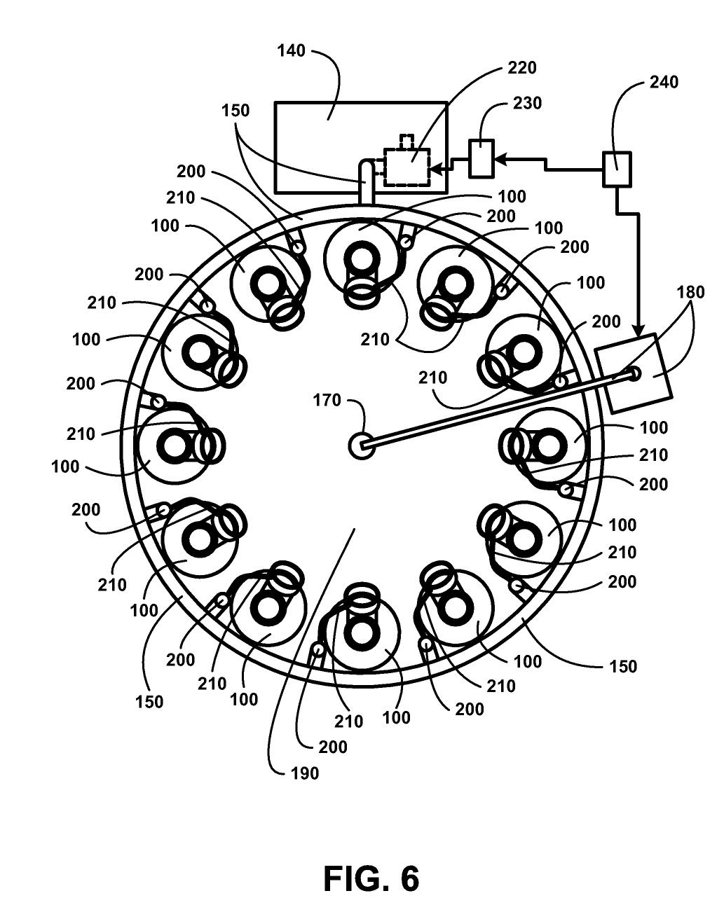

FIG. 6 shows for illustrative purposes only an example of a stackable cultivation tower system with multiple towers in a plan view of one embodiment of the present invention. The stackable cultivation tower system shown in FIG. 6 is configured for example with 12 stackable cultivation tower 100 assemblies placed in a circular pattern around the light source 170. This pattern provides exposure from the light source 170 illumination to all the plants being cultivated. The offset light source stand 180 base and post is positioned outside the circular pattern according to the length of the offset extensions. The light source 170 circuits attached to the offset light source stand 180 are connected to the power source 240. The reflector tray 190 is positioned on the exposed floor surface of the interior of the circular pattern below the light source 170.

The reflector tray 190 will reflect the light to the underside of the vegetation planted in each plant holder module 106 of FIG. of one embodiment of the present invention. The master irrigation feed line 150 is configured to connect to the pump 140 and extended up to a position above the 12 stackable cultivation tower 100 assemblies and further extended in a looping configuration. Individual irrigation feeder supply system 160 of FIG. 1 components are configured with the feeder line supply 200 for each of the 12 stackable cultivation tower 100 assemblies and connected to the looped master irrigation feed line 150. Connected to each of the feeder line supply 200 components are feeder line 210 components which are configured to deliver water to each of the plant holder module 106 components of the 12 stackable cultivation tower 100 assemblies of one embodiment of the present invention.

The pump 140 is configured as a submersible pump placed into the reservoir 140. Electricity is provided by a connection from the power source 240 to the timer 230. The pump 140 is connected to the timer 230 to allow for example the pump 140 to be operated at time intervals to produce optimal irrigation of the vegetation being cultivated. The configuration of the stackable cultivation tower system illustrated in FIG. 6 shows an example of 12 stackable cultivation tower 100 assemblies capable of cultivating for example 72 plants including optimal irrigation and lighting in a very small physical area to produce faster growth and higher yields per square foot of one embodiment of the present invention.

### Cool Vertical Light Tube System:

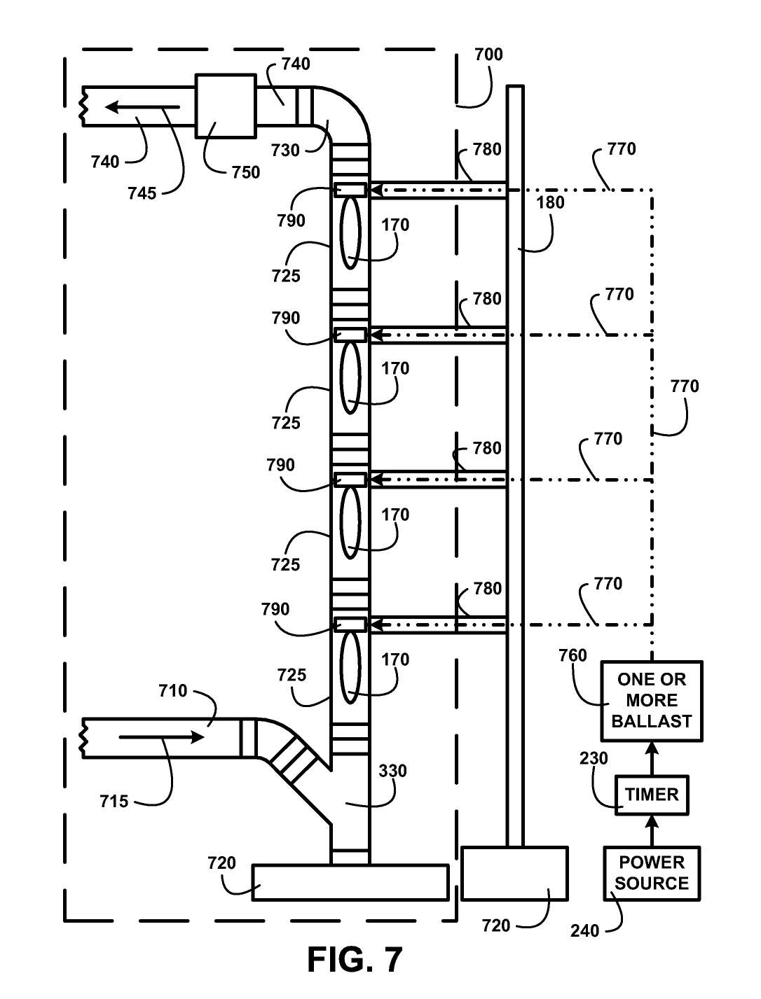

FIG. 7 shows a block diagram of a flow chart of a stackable cultivation tower system cool vertical light tube system of one embodiment of the present invention. FIG. 7 shows one embodiment of a cool vertical light tube system 700 which can be configured to attached to the offset light source stand 180. The cool vertical light tube system 700 can be configured to exhaust the heat produced by light source 170 bulbs to regulate the temperature of an indoor cultivation environment of one embodiment of the present invention.

The light source 170 bulbs can be configured to be installed on the offset light source stand 180 connected to a power source 240. A timer 230 can control the lighting luminescence pattern by turning power on an off at set time intervals to one or more ballast 760 used to power the light source 170 bulbs. The power to the light source 170 bulbs passes through one or more electric circuit 770 attached to for example one or more offset extension 780 of the offset light source stand 180. Each electric circuit 770 can be connected to a mogul socket 790 used to install and connect the light source 170 bulbs of one embodiment of the present invention.

The light source 170 can be configured for example as 400 to 1000 watt Metal Halide or High Pressure Sodium bulbs. The light source 170 bulbs can radiant substantial amounts of unregulated heat. The radiant heat warms the air that is surrounding the vegetation being cultivated. The unregulated heated air coming in contact with the vegetation can reach temperatures that can for example damage the plants causing wilting, drying or even kill the plant of one embodiment of the present invention. The cool vertical light tube system 700 provides a process to cool the air immediately surrounding each light source 170 and exhaust the heated air. The cool vertical light tube system 700 can be created using common materials. A base 720 can be configured as a weighted structure for example a block concrete or a support container 120 of FIG. 1. The base 720 can be configured to attach a slip-hub single wye 330. A cool air intake pipe 710 can be configured to extend from an outdoor inlet opening to a point of connection the angled end of the slip-hub single wye 330. The cool air intake pipe 710 allows cool air intake flow drawn from outdoors 715 into the sliphub single wye 330 of one embodiment of the present invention.

The vertical structure of the cool vertical light tube system 700 can be formed by stacking one or more translucent tube structure section 725 and attaching the lowest section to the slip-hub single wye 330. The translucent tube structure section 725 can be configured to use translucent or transparent materials that allow the light produced by the light source 170 to illuminate the vegetation of one embodiment of the present invention.

The cool air intake flow drawn from outdoors 715 passes around one or more light source 170 forcing the heated air to rise. The rising heated air flows a 90 degree elbow 730 attached to the top section of the cool vertical light tube structure to a section of exhaust pipe 740. The section of exhaust pipe 740 is connected to an exhaust ventilating fan 750. The exhaust ventilating fan 750 is powered from a power source 240 and can be configured to create an air flow for example 600 cubic feet per minute.

The exhaust ventilating fan 750 can be configured to additional sections of exhaust pipe 740 terminating at an outlet to the outdoors. The exhaust ventilating fan 750 forces the heated exhaust air flow to outdoors 745. The exhaust ventilating fan 750 operation can for example be controlled by a temperature sensitive thermostat thereby allowing the cool vertical light tube system 700 to regulate the temperature of the indoor cultivation environment of one embodiment of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following claims.

What is claimed is:

1. A stackable cultivation tower system for cultivating vegetation, comprising:
a method configured to economically cultivate vegetation by creating a facility from readily available parts including a vertical oriented planting structure,
a circulating irrigation system and lighting system in a reduced indoor physical area, conserving resources and promoting faster plant growth;
a stackable cultivation tower configured with multiple stackable plant modules assembled at varying heights above the floor level and configured where the bottom stackable plant module is attached to a post irrigation container inserted into a support container to form a vertical planting structure;
a stackable plant module configured with one or more plant holder module into which vegetation is placed;
a plant holder module configured to accept pots with planting medium into which vegetation has been planted;
a post irrigation container configured to collect water draining from each plant holder module down the inside of the stackable cultivation tower;
1(a) A stackable cultivation tower system for cultivating vegetation, comprising:
a support container configured to add physical stability to the tower;
a water return pipe configured to connect to the post irrigation container to allow the water collected in the post irrigation container to flow into a reservoir for reuse;
a reservoir configured to supply source of water and nutrients mixed in the water to irrigate and feed the vegetation and configured to include a pump;
a pump configured to force water from the reservoir up a master irrigation feed line and configured with a timer to regulate the irrigation cycles;
a timer configured to set time intervals in which to pump water up a master irrigation feed line to regulate the irrigation of the vegetation to promote optimal growth cycles;
a master irrigation feed line configured to convey the water to one or more irrigation feeder supply system;
an irrigation feeder supply system configured to convey water through a branching piping system to deliver water to the individual plants in each plant holder module wherein the water will drain into the post irrigation container;
an offset light source stand configured to connect to a power source to supply electricity to one or more light source connected to sockets attached to extension elements of the stand structure to allow one or more light source to be in close proximity to the vegetation without illumination be obstructed by the stand structure;
a light source configured to provide various lighting wave lengths to promote optimal vegetative growth and configured to connect to electrical circuits attached to the offset light source stand at multiple heights above the floor level to cast light onto the vegetation being cultivated;
a cool vertical light tube system for exhausting the heat produced by light source bulbs to regulate the temperature of an indoor cultivating environment;
a reflector tray configured to provide reflected illumination to the underside of vegetation shaded from direct exposure to a light source; and;
a coliseum tower arrangement configured to position multiple stackable cultivation towers in a circular pattern to allow cultivation of many plants vertically in a very small physical area to produce faster growth and higher yields per square foot.

2. The system of claim 1, wherein the stackable plant modules are readily available parts, that incorporate elements such as one or more angled wye pipe sections which is used as plant holder modules.

3. The system of claim 1, wherein the stackable plant modules incorporate features such as hub and slip ends allowing the interconnection in an end to end configuration to form a vertical structure.

4. The system of claim 1, wherein the offset light source stand is assembled from readily available parts that include parts such as PVC pipes, electrical junction boxes, electrical sockets and electrical conductor cables.

5. The system of claim 1, wherein the circulating irrigation system is assembled from readily available parts that include parts such as PVC pipes, poly tubing, pipe and tubing fittings, containers, pumps and timers.

6. A stackable cultivation tower assembly creating a vertical cultivation facility to plant and irrigate vegetation from readily available parts, comprising: a stackable cultivation tower configured to form a vertical planting structure by connecting stackable plant modules end to end in a vertical orientation to allow multiple plants to be cultivated in a small physical area;
a stackable plant module configured to one or more plant holder module into which vegetation planted in pots are placed;
a plant holder module configured to hold a mesh pot filled with planting medium into which vegetation is planted for cultivation;
a mesh pot configured to be filled with planting medium and into which vegetation is planted and configured with narrow slots or mesh patterned openings through which water drains into a post irrigation container;
a post irrigation container configured to collect water draining from the mesh pots placed in the plant holder modules and configured to insert into a support container;
a support container configured to add physical stability to the tower;
a water return pipe configured to connect to the post irrigation container to allow the water collected in the post irrigation container to flow into a reservoir for reuse as part of a circulating irrigation system;
a reservoir configured to supply source of water and nutrients mixed in the water to irrigate and feed the vegetation and configured to include a pump;
a pump configured to forces water from the reservoir up a master irrigation feed line and configured to connect to a timer to control the pumping operation;
a timer configured to regulate the irrigation cycle by setting time intervals in which the pump operation pumps water up the master irrigation feed line;
a master irrigation feed line configured to convey the water to one or more irrigation feeder supply system;
an irrigation feeder supply system configured to convey water through a branching irrigation piping element configured to include a feeder line supply attached to the stackable cultivation tower;
a feeder line supply configured to attach to the stackable cultivation tower and supply water to multiple feeder line tubing to deliver water to the individual plants; as a branching piping system to deliver water to the individual plants in each plant holder module;
a feeder line configured to connect through or attach to a plant holder module to deliver water to the individual plants;

7. The stackable plant module of claim 6, wherein the stackable plant modules include readily available parts such as PVC all hub single wyes, slip-hub single wyes and all hub double wyes which be connected using lengths of cut pipe as an interior couplings or which a slip end slides into one hub end.

8. The mesh pot of claim 6, wherein the mesh pot includes readily available parts such as bowl or conical shaped plastic containers with narrow slots or mesh patterned openings through which water drains.

9. The pump of claim 6, wherein the pump is configured as a submersible pump placed inside the reservoir.

10. An offset light source stand device for connecting one or more light source to a power source and to allow a light source to be in close proximity to the vegetation without the illumination being obstructed by the stand structure, comprising:
a vertical post configured to support and connects multiple extension elements at multiple heights above the floor level;
an extension element configured to cantilever at various distances from the vertical post to create an offset and configured to allow electrical junction boxes to be attached at the free terminating end of the extension element;
an electrical junction box configured to connect electrical conductors to supply electricity to light lamp or bulb electrical sockets;
an electrical socket configured to allow insertion of multiple types of light lamps or bulbs to provide various wave length illuminations to the vegetation being cultivated;
an electrical cable configured to connect to a power source and configured to attach to the vertical post and extension elements to supply electricity to multiple light sources;
a cool vertical light tube system for exhausting the heat produced by light source bulbs to regulate the temperature of an indoor cultivating environment;
and;
a reflector tray configured to reflect the light source illumination on the underside of the vegetation to allow full illumination to all portions of the vegetation.

11. The offset light source stand of claim 10, wherein the offset light source stand is assembled from readily available parts that include parts such as PVC pipes, electrical junction boxes, electrical sockets and electrical conductor cables.

12. The light source of claim 10, wherein the light source includes readily available lamps or bulbs that provide different wave lengths of light, such as are produced with High Pressure Sodium and Metal Halide lamps.

13. The reflector tray of claim 10, wherein the reflector tray is assembled from readily available materials such as sheets of Mylar which have a reflective characteristic.

14. The cool vertical light tube system of claim 10, wherein the cool vertical light tube system is configured to include cool air intake piping to allow cooler ambient air from outdoors to be drawn into the cool vertical light tube structure.

15. The cool vertical light tube system of claim 10, wherein the cool vertical light tube system is configured to include connection to the top of the cool vertical light tube structure of sections of exhaust pipe connected to an exhaust ventilating fan and continuing sections of exhaust pipe from the exhaust ventilating fan to an outdoor outlet to allow the exhaust ventilating fan to force air heated by one or more light source to exhaust to outdoors.

16. The cool vertical light tube system of claim 10, wherein the cool vertical light tube structure is configured to include vertical sections formed by stacking one or more translucent tube structure section wherein the translucent tube structure sections are configured to use translucent or transparent materials that allow the light produced by the light source to illuminate the vegetation.

17. The cool vertical light tube system of claim 10, wherein the exhaust ventilating fan is configured to have a controlled operation using a temperature sensitive thermostat to turn off and on the fan thereby allowing the cool vertical light tube system to regulate the temperature of the indoor cultivation environment.
